(19) United States
(12) Patent Application Publication
(10) Pub. No.: US 2017/0014962 A1
(43) Pub. Date: Jan. 19, 2017

(54) VEHICLE DIFFERENTIAL SUPPORT STAND

(71) Applicant: John A. Melchiori, Crystal Falls, MI (US)

(72) Inventor: John A. Melchiori, Crystal Falls, MI (US)

(21) Appl. No.: 14/801,580

(22) Filed: Jul. 16, 2015

(51) Int. Cl. B23Q 16/06; B25H 1/00; B25B 11/00

(52) U.S. Cl. CPC B23Q 16/06; B25B 11/00; B25H 1/0007

(57) ABSTRACT

A support stand for facilitating the repositioning of a work piece undergoing repair includes a base member in which a spindle is journaled for rotation about a vertical axis and affixed to the upper end of the spindle is a generally U-shaped yoke having parallel, spaced-apart arms between which a work piece support member is journaled for rotation about horizontal axis. A detent mechanism is provided for releasably latching the spindle in any one of a plurality of angular positions relative to the base. Similarly, a detent mechanism is provided between the yoke and the work piece support member for latching it in one of a plurality of angular positions.

### CROSS REFERENCE TO RELATED APPLICATIONS

None

### STATEMENT ON GOVERNMENT SPONSORSHIP

None

### BACKGROUND OF THE INVENTION

I. Field of the Invention

This invention relates generally to apparatus for facilitating repairs of unwieldy machine parts and more particularly to a bench-mounted support stand for use in performing repair operations and that allows ready repositioning of such machine parts.

II. Discussion of the Prior Art

In performing repair procedures on heavy and bulky work pieces, manually repositioning them to gain purchase to operating parts is often quite difficult. Most work bench-mounted vises may be used to hold a work piece but, typically, such vises do not permit the work piece to be moved without first opening the vise jaws and shifting the orientation of the work piece before retightening the jaws.

An early U.S. Pat. No. 1,815,501 to Odin discloses a “universal vise” having an upright vertical rod clamped to a work bench and adjustably mounted on the vertical rod is a horizontal rod on which the vise's jaws are mounted. The arrangement is such that the horizontal rod can be raised and lowered on the vertical rod and also rotated about the vertical rod through 360 degrees. Likewise, the vise jaws can be swiveled about the horizontal rod, thereby allowing a work piece carried between the vise jaws to be repositioned relative to a worker stationed at the workbench. While the Odin patent discloses a design that allows for reorienting a work piece clamped between the screw-operated jaws of a vise arrangement, its capacity is limited by the span of the horizontal rod. Thus, it is unable to hold and manipulate all but relatively small and lightweight work pieces.

A need therefore exists for a tool that can allow a work piece having the size, shape and weight of an automobile or truck differential gear assembly, often called a “rear end” or a “removable third member”, and that facilitates positioning same so that a mechanic can readily perform assembly and repair operations thereon. It is the purpose of the present invention to provide such a device.

### SUMMARY OF THE INVENTION

The support stand of the present invention comprises a base member having a flat plate adapted to be affixed to a planar surface and having a tubular collar affixed to the base plate and projecting perpendicularly upward from it. Journaled for rotation within the tubular collar is a spindle having a sleeve bearing mounted thereon, allowing the spindle to rotate about a vertical axis. Also secured to the spindle is a detent ring, the ring having a plurality of recesses regularly spaced about its periphery. A generally circular bearing retainer plate is affixed to the upper end of the spindle, and joined to the bearing retainer plate is a U-shaped yoke in which a work piece support member is journaled for rotation about a horizontal axis.

### DESCRIPTION OF THE DRAWINGS

The foregoing features, objects and advantages of the invention will become apparent to those skilled in the art from the following detailed description of a preferred embodiment, especially when considered in conjunction with the accompanying drawings in which like numerals in the several views refer to corresponding parts.

FIG. 1 is a perspective view of the vehicle differential support stand comprising a preferred embodiment of the present invention;

FIG. 2 is an enlarged front view of the vehicle differential support stand;

FIG. 3 is a perspective view of the spindle incorporated into the base member of the embodiment of FIG. 1;

FIG. 4 is a perspective view showing the spindle of FIG. 3 but with a sleeve bearing and detent ring assembled thereon;

FIG. 5 is a detailed view of a yoke shown in the perspective view of FIG. 1;

FIG. 6 is a perspective view of the work piece support member of the assembly of FIG. 1; and

FIG. 7 is a perspective view of a detent member for releasably locking the work piece support member relative to the yoke.

### DESCRIPTION OF THE PREFERRED EMBODIMENTS

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise.

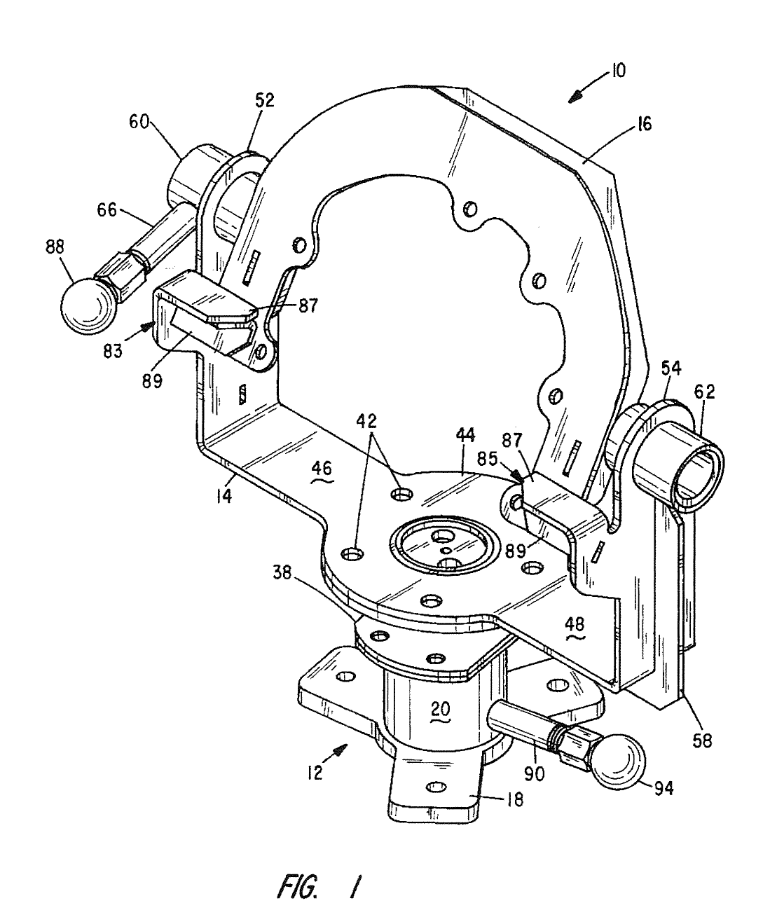

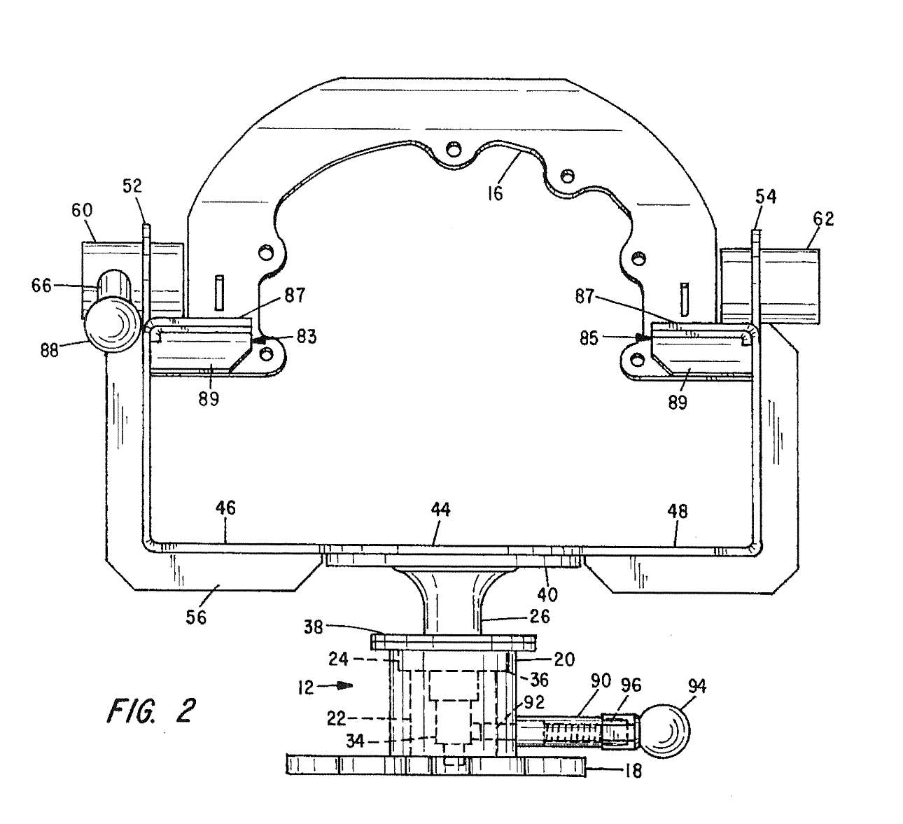

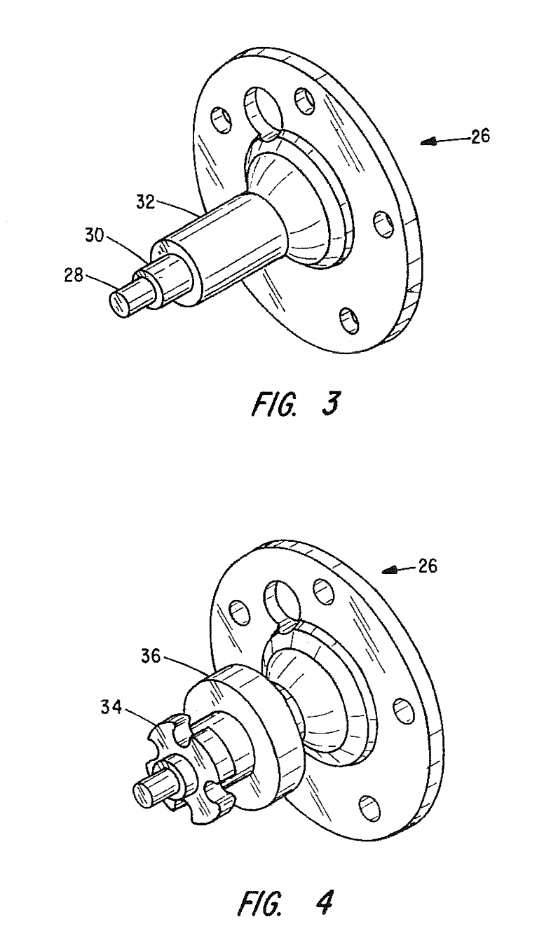

Referring first to FIG. 1, the vehicle differential support stand is identified generally by numeral 10 and is comprised of three main parts, namely, a base member 12, a yoke 14 and a work piece support member 16. With continued reference to FIG. 1 and to the view of FIG. 2, the base member 12 is seen to comprise a lower, three-legged flat plate 18 to which is welded a tubular collar in the form of a cylindrical tube 20 having a bore 22 and a counter bore 24. Journaled for rotation within the base 12 is a spindle 26 which is more clearly shown in the perspective views of FIGS. 3 and 4. The shaft of the spindle has a lower, relatively small diameter segment 28, a segment 30 of an intermediate diameter and a segment 32 of a relatively larger diameter. The small diameter portion 28 is adapted to fit within a central hole formed in the base plate 18 and pressed fit onto the intermediate diameter portion 30 of the spindle 26 is a detent ring 34. A pressed-on sleeve bearing 36 surrounds the larger diameter portion 32 of the spindle. The sleeve bearing 36 is dimensioned to fit within the counter bore 24 of the tubular collar 20 and is held in place by a bearing retainer plate 38. Those skilled in the art can appreciate that the spindle 26 is thus journaled for rotation in the base member 12.

Attached to the upper end of the spindle 26 is a mounting plate 40 to which the yoke 14 is bolted by screws passing through the apertures 42 in a flat, circular portion 44 of the yoke and into tapped, threaded holes in the mounting plate 40.

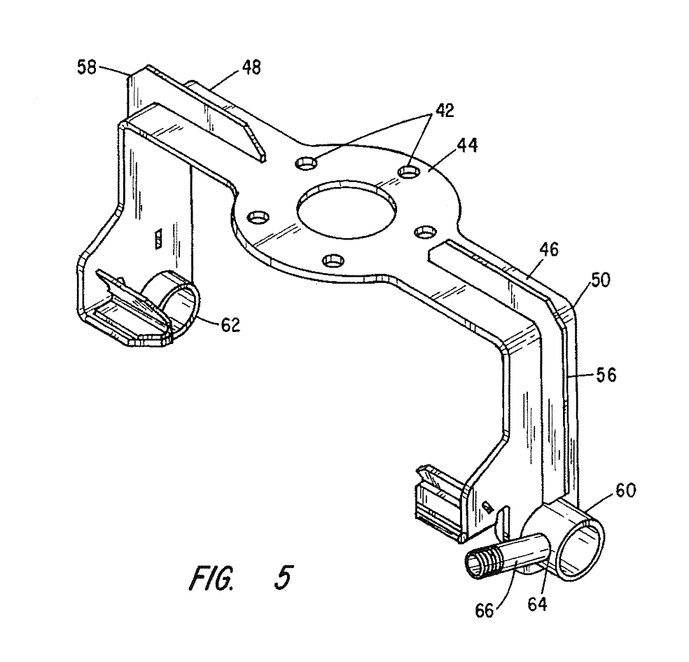

Turning next to FIG. 5 showing a detail of the yoke, it is seen to comprise the circular center section 44 that is integrally formed with diametrically opposed laterally extending arms 46 and 48 that are bent, as at 50, at a 90° angle so as to extend upwards and terminating in a semi-circular radius 52, 54 (FIG. 1). Gusset strips 56 and 58 are welded to the arms 46 and 48 to impart greater rigidity to the yoke member.

As seen in FIG. 5, a pair of outer tubes 60 and 62 extend through apertures formed in the end portions of the arms 46 and 48 and are welded in place. The outer tube 60 has an aperture 64 formed through its wall surface and fitted into this aperture is a detent tube 66.

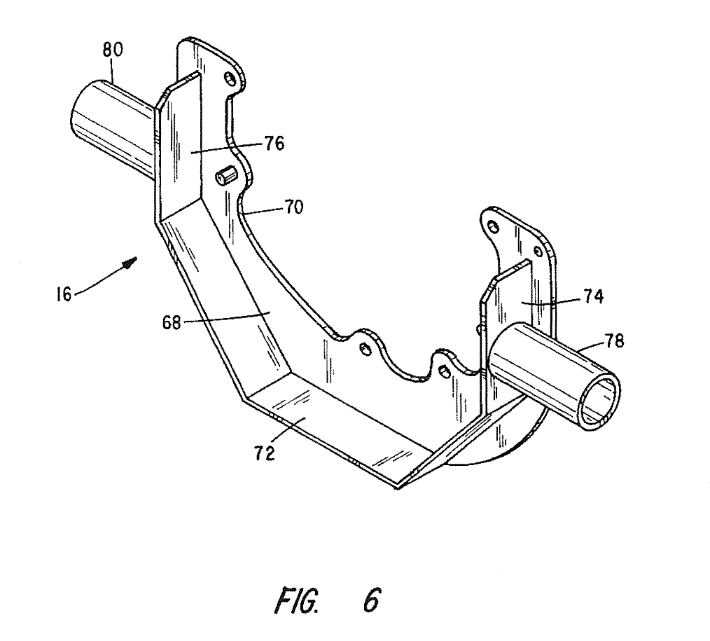

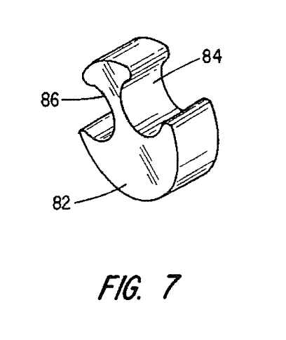

In FIG. 6 there is illustrated a perspective view of the work piece support member 16 of FIG. 1. It is seen to comprise a flat, semicircular steel plate 68 having an arcuate cutout 70 especially designed to accommodate a shape profile of a work piece. Welded to the plate 68 is a wall 72 that approximates a segment of an octagon 72. Welded to the wall portions identified by numerals 74 and 76 are inner tube members 78 and 80. They are referred to as “inner tube members” in that they are designed to concentrically fit within the outer tubes 60 and 62 of the yoke 14. Tolerances are such that the work piece support member 16 can be made to rotate relative to the yoke arms 56 and 58. While the cooperation of the inner and outer tubes provides a satisfactory journal for certain smaller differentials, if heavier designs are to be worked on, it is expedient to insert a set of bearings between the inner and outer tubes. Fitted into the interior of the inner tube 80 is a detent member 82, the shape of which is shown in FIG. 7. It comprises a circular plate having grooves 84, 86 formed inward from the periphery thereof, the grooves having an arcuate profile and preferably being centered 120° apart. The detent member 82 is press fit into the lumen of the inner tube 80 and designed to cooperate with a spring-loaded detent pin contained within the detent tube 66. A spherical grip member 88 is attached to one end of the plunger and its other end cooperates with the detent member 82 to releasably lock the angular setting of the work piece support 16. By pulling rearward on the grip 88, the plunger is retracted against the force of the spring so that its inner end no longer is fitted within one of the grooves 84, 86, thereby allowing rotation of the work piece support 16 relative to the yoke 14. Releasing the grip while rotating the work piece support allows the end of the plunger to engage one of the grooves 84 or 86 to lock the work piece at a selected angle.

Also welded to the end portions of the arms 46 and 48 are stop tabs 83 and 85 that have a horizontal working surface 87 and a working surface 89 whose exterior angle is 120° from the horizontal working surface. Thus, the work piece support plate may be oriented either horizontally or at 120° to the horizontal due to engagement of the steel plate 68 of the work piece support member 16 with the working surfaces of the tabs 83 and 85. It may also prove expedient to provide a means for adjusting the angle slightly to accommodate wear over time by drilling and tapping a bolt hole through the stop tab 89 and inserting a bolt through the tapped hole. A jam nut on the bolt will maintain the extent of penetration of the bolt beyond the plane of the tab 89.

A similar detent device is provided in the base 12 to lock the spindle 26 and therefore the yoke 14 in any one of a plurality of angular dispositions. As seen in FIG. 2, a detent tube 90 is fitted into an aperture of the base tube 20 and disposed within the tube 90 is a plunger 92 designed to cooperate with the detent ring 34 and having a spherical grip 94 on a proximal end thereof. A compression spring 96 also contained within the detent tube 90 normally urges the plunger 92 into engagement with the detent ring 34. However, by pulling rearward on the spherical grip 94 against the force of the spring, the plunger becomes disengaged from a groove on the detent ring 34, thereby allowing the spindle to be rotated and with it, the yoke 14 and the work piece support member 16.

In operation, the device of FIG. 1 would be bolted to a work bench or other stable surface by suitable fasteners passing through the apertures on the multi-legged base plate 18. A work piece, such as an automotive differential, can then be fastened by bolts to the work piece support member. The mechanic working on the differential may then set the work piece at a desired angle by first pulling on the plunger's spherical grip 94 and rotating the assembly about a vertical axis. Next, if desired, the mechanic may orient the work piece at a desired angle by first retracting the plunger contained within the detent tube 66 until the plunger no longer engages with the detent member 82 and then rotating the work piece about the rotational axis that extends between the upper ends of the yoke arms 46 and 48.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and be used with a variety of work pieces. Also, various modifications, both as to the equipment and operating procedures, can be accomplished without departing from the scope of the invention itself.

What is claimed is:

1. A support stand for a work piece comprising:
a) a base member having a flat base plate adapted to be affixed to a planar surface and with a tubular collar affixed to the base plate projecting upwardly from the base plate;
b) a spindle with a sleeve bearing mounted thereon for journaling the spindle within the tubular collar for rotation about a vertical axis;
c) a detent ring affixed to the spindle, the detent ring having a plurality of recesses regularly spaced about its periphery;
d) a generally circular bearing retainer plate affixed to an upper end portion of the spindle;
e) a U-shaped yoke joined to the bearing retainer plate for rotation therewith; and
f) a work piece support member journaled in the yoke for rotation about a horizontal axis.

2. The support stand of claim 1 wherein the base member includes a means for releasably locking the spindle at predetermined angular locations.

3. The support stand of claim 1 wherein the yoke includes means for releasably locking the work piece support member at predetermined angular locations.

4. The support stand as in claim 1 wherein the tubular collar includes:
a) a radial bore extending through a peripheral wall thereof;
b) a detent tube fitted into the bore; and
c) a spring loaded plunger slidably mounted in the detent tube, the plunger having first and second ends, the first end having a grip member thereon and the second end adapted to cooperate with the recesses of the detent ring.

5. The support stand of claim 1 wherein the yoke comprises a centrally located circular disk affixed to the bearing retainer plate and with first and second arms integrally joined to the disk and extending diametrically and radially therefrom for a first predetermined distance and then bent perpendicularly in an upward direction and extending for a second predetermined distance terminating in end portions.

6. The support stand of claim 5 and further including an outer tubular sleeve extending through each of the end portions of the first and second arms.

7. The support stand of claim 6 wherein the centrally located circular disk is fastened to the generally circular bearing retainer plate.

8. The support stand of claim 6 wherein the work piece support member comprises:
a) a generally U-shaped plate having a wall member welded to an upper surface of the generally U-shaped plate and projecting normal therefrom; and
b) first and second inner tubular sleeves affixed to the wall member and extending outwardly therefrom so as to concentrically fit within the outer tubular sleeves that extend through end portions of the first and second arms with a predetermined clearance therebetween.

9. The support stand as in claim 8 and further including a detent member affixed in a lumen of one of the first and second inner tubular sleeves, the detent member having a plurality of grooves formed inward from a peripheral surface thereof.

10. The support stand as in claim 9 and further including:
a) concentric aligned apertures formed through walls of the inner and outer tubular sleeves;
b) a detent guide tube affixed to the outer tubular sleeve surrounding said apertures; and
c) a reciprocally movable spring loaded plunger contained in the detent guide tube and having first and second ends with a grip member affixed to the first end, the second end of the plunger adapted to engage a selected one of the plurality of grooves in the detent member.

11. The support stand as in claim 9 wherein the generally U-shaped plate of the work piece support member includes a plurality of apertures formed through a thickness dimension thereof and adapted to receive fasteners therethrough for securing a work piece to the work piece support member.
